(19) United States
(12) Patent Application Publication
(10) Pub. No.: US 2014/0035567 A1
(43) Pub. Date: Feb. 6, 2014

(54) POSITION SENSOR, IN PARTICULAR FOR DETERMINING THE POSITION OF A ROTOR OF A PLANAR DIRECT DRIVE

(71) Applicant: Eckhard Wendorff, Zella-Mehlis (DE)

(72) Inventor: Eckhard Wendorff, Zella-Mehlis (DE)

(73) Assignee: Schaeffler Technologies AG & Co. KG, Hertzongenaurach (DE)

(21) Appl. No.: 14/112,206

(22) PCT Filed: Apr. 5, 2013
(86) PCT No.: PCT/EP2012/056322

§ 371 Date: Oct. 16, 2013

(30) Foreign Application Priority Data
Apr. 22, 2011 (DE) 102011002254.6

(51) Int. Cl. G01B 7/30

(52) U.S. Cl. CPC G01B 7/30
USPC 324/207.25

(57) ABSTRACT

A position sensor in particular for determining the position of a rotor of a planar direct drive, including a pan- or box-shaped, softmagnetic base body (01), at least one permanent magnet (02) arranged within the base body (01), wherein the north pole-south pole axis of the permanent magnet (02) extends perpendicularly to an open base surface of the base body (01), poles (03) having a tooth structure (04) and being arranged on the permanent magnet (02) in two rows parallel to the measurement direction, wherein the tooth flanks of the tooth structure (04) run parallel to a plane extending through the north pole-south pole axis of the permanent magnet (02), and further comprising sensors (05) arranged between the poles (03) for determining the field strength and/or the magnetic flux.

The present invention relates to a position sensor, in particular for determining the position of a rotor of a planar direct drive.

Planar direct drives, also referred to as planar motors, are known from the prior art. In this regard, reference is made, for example, to WO 2007/135006 A1, which describes a planar direct drive which includes a flat passive unit having magnetizable teeth and an active unit having coils for generating a variable magnetic flux.

Position sensors according to the field of the present invention are used in linear and planar direct drives for determining the position of the rotor in relation to the tooth structure of the stator.

A Hall position sensor, in particular for the planar fine positioning in the μ range, is known from DE 195 13 325 A1. The disadvantage of this position measuring device is that the hysteresis is relatively large. Another disadvantage is the dependency of the sensor signals on the speed of the rotor movement.

DE 101 03 478 A1 describes a position sensor for the armature of an electromagnetic stepper motor. The position sensor includes two multipart, U-shaped magnetic conductors, teeth being provided on the poles of the iron cores of each magnetic conductor, and the difference of the group coordination of the teeth being equal to (a±0.5)Z (a=any integer, Z=the period of the arrangement of teeth). A permanent magnet is series-connected to one of the parts of the U-shaped magnetic conductor. Magnetic induction converters are mounted structurally or in magnetic relationship near a pair of equally named magnet poles of the iron cores of a pair of U-shaped magnetic conductors in such a way that the output signal of the converters is in direct proportion to the difference in the magnetomotive force of these magnet poles. The disadvantage of this position sensor is that the north pole-south pole of the permanent magnet runs perpendicularly between the teeth of the magnetic conductor, whereby the magnetic flux always runs through two poles. As a result, the generated sensor signal is relatively weak and also sensitive to magnetic interference fields.

### SUMMARY OF THE INVENTION

It is an object of the present invention to provide a position sensor, based on DE 101 03 478 A1, which supplies a stronger sensor signal and is relatively insensitive to magnetic interference fields.

The present invention provides a position sensor having a pan-shaped or box-shaped base body made of a softmagnetic material. At least one permanent magnet is situated within this base body in such a way that its north pole-south pole axis runs perpendicularly to an open base surface of the base body. Poles having a tooth structure are situated on this permanent magnet in two rows parallel to the measuring direction, the tooth flanks of the tooth structure running parallel to a plane which encompasses the north pole-south pole axis of the permanent magnet. Sensors for ascertaining the field strength and/or the magnetic flux are located between the poles.

One essential advantage of the sensor according to the present invention is that, due to the arrangement of the permanent magnet, the magnetic flux, which results when the magnetic circuits close, always runs through only one pole of the sensor. For this reason, much stronger sensor signals may be generated, compared to the prior art. Implementing a higher magnetic modulation results in a reduced susceptibility to residual magnetic fields. A higher useful signal level is also available. Since the permanent magnet is no longer situated between the poles of the sensor, a smaller lateral distance between the poles may be implemented, and thus a smaller expansion of the position sensor, which provides the advantage of less sensitivity to twisting. The magnetic modulation of the individual poles may be set separately. Since the poles are no longer series-connected, this also eliminates the problem of mutual influencing of the magnetic flux.

The base body, which may have a one-part or multi-part design, is used as a magnetic shielding, in addition to its function as a sensor housing, and thus ensures the magnetic and electromagnetic shielding of the poles and the sensors. In particular, a shielding against magnetic interference fields from the motor air gap (short-circuit of these fields) as well as an all-around shielding against electromagnetic fields take place. The shielding function of the base body ensures that the magnetic fields of the drive have only a negligible influence on the measuring signals of the sensors. A constant premagnetization for the stator section used is also achieved by the base body. Disturbances in the measuring signals produced by premagnetization are thus largely prevented.

In one advantageous specific embodiment, the sensor has six poles. The tooth structure of the poles located in a first row is offset by a quarter period, and the tooth structure of the poles situated in a second row is offset by a half period in relation to the first row.

A permanent magnet, which is preferably designed as a magnetic plate, may be used as the source generating the measuring magnetic field. However, it is furthermore also possible to use, for example, six permanent magnets distributed at regular intervals on the base body. The magnetic plate and the individual permanent magnets take up the same amount of installation space.

According to another advantageous specific embodiment, the position sensor is designed with eight poles. In this embodiment, the tooth structure of a second pole located in a first row is offset by a 0.5 period, the tooth structure of a third pole located in a first row is offset by a 0.25 period, the tooth structure of a fourth pole located in a first row is offset by a 0.75 period, and the tooth structure of the poles situated in a second row is offset by a half period in relation to the first row. A permanent magnet designed as a magnetic plate may also be used in this specific embodiment. Alternatively, eight permanent magnets may also be used.

It is advantageous to situate the position sensor on a plate made of a softmagnetic material. The magnetic circuits, which include the permanent magnets, the poles and the box-shaped base body, close due to the softmagnetic plate.

In one preferred specific embodiment, the softmagnetic plate is a stator section which has a tooth structure. It has proven to be favorable if the period of the tooth structure of the individual poles corresponds to the period of the tooth structure of the stator.

Further advantages, details and refinements of the present invention result from the following description of one preferred specific embodiment with reference to the drawings.

### BRIEF DESCRIPTION OF THE DRAWINGS

FIG. 1 shows a sensor according to the present invention, viewed from above;

FIG. 2 shows the sensor according to the present invention in a sectional representation along line A-A in FIG. 1;

FIG. 3 shows the sensor according to the present invention in a sectional representation along line B-B in FIG. 1.

### DETAILED DESCRIPTION

A sensor according to the present invention includes a pan-shaped or box-shaped, softmagnetic base body 01. Base body 01 has a one-part or multi-part structure and encloses the sensor on its side surfaces and the cover surface. The base surface opposite the cover surface remains at least partially open. In the specific embodiment illustrated herein, a permanent magnet 02 in the form of a magnetic plate is situated in the interior of this base body 01. In alternative specific embodiments, multiple, individual permanent magnets 02 may be used. The individual magnets and the magnetic plate essentially take up the same amount of installation space. Three poles 03 are situated on permanent magnet 02 in two rows parallel to the measuring direction. Of course, a different number of poles is also possible. For example, an arrangement of a total of eight poles 03 has proven to be advantageous.

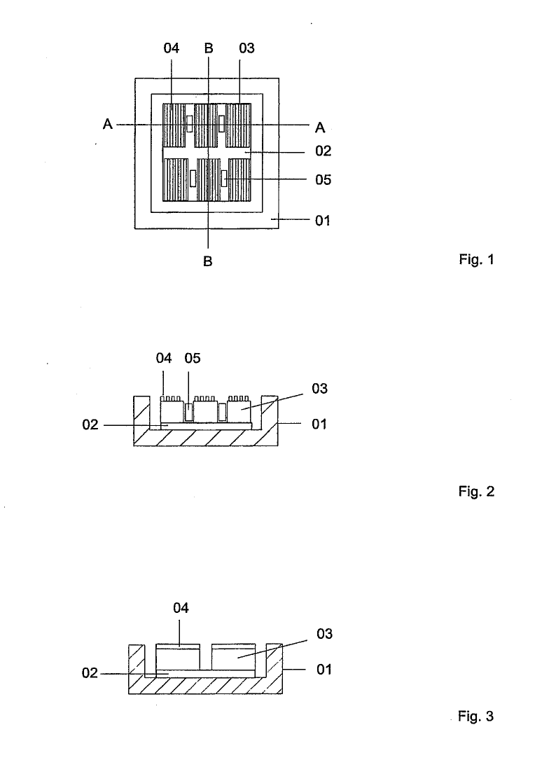

Poles 03 have a tooth structure 04. The tooth flanks of tooth structure 04 run parallel to a plane which encompasses the north pole-south pole axis of permanent magnet 02. As is apparent, in particular, in FIG. 1 or FIG. 2, tooth structure 04 of poles 03 located in a first row is offset by a quarter period. Tooth structure 04 of poles 03 situated in a second row is offset by a half period in relation to the first row.

Sensors 05, which are used to ascertain the field strength and/or the magnetic flux, are situated between poles 03. Magnetoresistive sensors or Hall sensors, for example, may be used as sensors.

If the sensor according to the present invention is situated on a softmagnetic plate (not illustrated), a total of six magnetic circuits, which include permanent magnet 02, poles 03 and base body 01, close in the illustrated specific embodiment. The field lines of each circuit each run through only one pole 03 of the sensor, due to the north pole-south pole axis of permanent magnet 02, which is perpendicular to the running surface of the drive.

Base body 01 is not only used as the sensor housing but simultaneously provides a magnetic and electromagnetic shielding of poles 03 and of sensors 05. For this purpose, base body 01 is essentially magnetically closed, with the exception of the base surface on which tooth structure 04 of the poles is located. Base body 01 also ensures an equivalent, constant magnetization of the running surface of the drive in the area covered by the sensor. According to one advantageous specific embodiment, the running surface is a stator section. The stator section has a tooth structure. The period of tooth structure 04 of individual poles 03 advantageously corresponds to the period of the tooth structure of the stator section.

The sensor according to the present invention may be attached to the rotor of the direct drive or be integrated therein. The poles of the sensor are then advantageously located on the same plane as the pole teeth of the rotor.

### LIST OF REFERENCE NUMERALS

01—Base body
02—Permanent magnet
03—Poles
04—Tooth structure
05—Sensor

1-7. (canceled)

8. A position sensor comprising:
a pan-shaped or box-shaped soft magnetic base body having an open base surface;
at least one permanent magnet situated within the base body, a north pole-south pole axis of the permanent magnet running perpendicularly to the open base surface;
poles having a tooth structure situated on the permanent magnet in two rows parallel to a measuring direction, tooth flanks of the tooth structure running parallel to a plane encompassing the north pole-south pole axis of the permanent magnet; and
sensors for ascertaining at least one of a field strength and a magnetic flux situated between the poles.

9. The position sensor as recited in claim 8 wherein the poles include six poles, the tooth structure of the poles located in a first row being offset by a quarter period, and the tooth structure of the poles situated in a second row being offset by a half period in relation to the first row.

10. The position sensor as recited in claim 9 wherein the permanent magnet is divided into multiple permanent magnet sections distributed at regular intervals on the base body, each permanent magnet section aligned with one of the poles in the axial direction.

11. The position sensor as recited in claim 8 wherein the poles include eight poles, the tooth structure of a second pole located in a first row being offset by a 0.5 period, the tooth structure of a third pole located in the first row being offset by a 0.25 period, the tooth structure of a fourth pole located in the first row being offset by a 0.75 period, and the tooth structure of the poles situated in a second row being offset by a half period in relation to the first row.

12. The position sensor as recited in claim 8 wherein the position sensor is situated in or on a rotor of a direct drive.

13. The position sensor as recited in claim 8 wherein the base body completely encloses the other components of the position sensor on the sides and on a cover surface, while the open base surface opposite the cover surface is at least partially open to expose the poles.

14. The position sensor as recited in claim 8 wherein a period of the tooth structure of the individual poles corresponds to the period of the tooth structure of a stator of a direct drive.

15. A position sensor for determining the position of a rotor of a planar direct drive, comprising the position sensor as recited in claim 8.
